(19) United States
(12) Patent Application Publication
(10) Pub. No.: US 2014/0019384 A1
(43) Pub. Date: Jan. 16, 2014

(54) UTILITY METER SYSTEM

(71) Applicants: James Patrick Hanley, Decatur, GA (US); Hyoung Jhang, Johnscreek, GA (US); Jeremy James McKeown, Stockbridge, GA (US)

(72) Inventors: James Patrick Hanley, Decatur, GA (US); Hyoung Jhang, Johnscreek, GA (US); Jeremy James McKeown, Stockbridge, GA (US)

(73) Assignee: GENERAL ELECTRIC COMPANY, Schenectady, NY (US)

(21) Appl. No.: 13/545,940

(22) Filed: Jul. 10, 2012

(51) Int. Cl. G06Q 30/00; G08C 15/06

(52) U.S. Cl. 705/412; 340/870.02

(57) ABSTRACT

A system includes a utility head end and a utility meter. The utility meter is configured to communicatively couple to the utility head end. The utility meter includes a metrology processor and a head end communications module. The metrology processor is configured to read a measurement. The head end communications module is configured to communicate with the utility head end to transmit the measurement to the utility head end.

### BACKGROUND OF THE INVENTION

The subject matter disclosed herein relates to utility systems, and more specifically, to systems to measure and manage utility consumption.

A utility system provides utilities (e.g., electricity, gas, or water) to facilities connected to a distribution system (e.g., power grid). Each facility may have a meter (e.g., a power meter, gas meter, or water meter) that measures utility consumption and transmits information back to a utility service. Periodically, it may be desirable to reconfigure the meter or install a new meter to add enhancements or new functionality to the meter. Unfortunately, this may result in manual replacement of each individual meter of the utility system, and may be inefficient, time-consuming, and expensive.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a utility head end and a utility meter. The utility meter is configured to communicatively couple to the utility head end. The utility meter includes a metrology processor and a head end communications module. The metrology processor is configured to read a measurement. The head end communications module is configured to communicate with the utility head end to transmit the measurement to the utility head end.

In a second embodiment, a system includes a utility head end configured to communicate with a utility meter. The utility head end includes a non-transitory machine-readable medium that has code configured to receive a measurement from the utility meter and to receive a timestamp of the measurement. The code is also configured to calculate pricing information based on the measurement, the timestamp, and a pricing strategy of a meter application intelligence (MAI).

In a third embodiment, a method includes receiving a signal related to a measurement of a utility and deriving the measurement from the signal. The method also includes calculating pricing information based on the measurement, the timestamp, and a pricing strategy of a meter application intelligence remote from a utility meter. Further, the method includes transmitting the pricing information to at least one of a regulatory system or the utility meter.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a utility system that generates, transmits, and distributes a utility;

FIG. 2 is a block diagram of an embodiment of the utility system of FIG. 1, illustrating a smart meter having a meter application intelligence (MAI); and

FIG. 3 is a block diagram of an embodiment of the utility system of FIG. 1, illustrating a simplified smart meter and a MAI-enabled head end.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed to systems and methods to improve the efficiency and scalability of utility systems by simplifying the hardware of a smart meter. In particular, meter application intelligence (MAI) hardware and software can be removed from the meter and relocated to a head end of a utility service that is remote from the meter itself The MAI may provide various functionalities to the meter and to the utility service, such as event logging, tamper event sensing, and pricing strategy implementation. As discussed earlier, it may be desirable to periodically update the smart meter to provide for software or firmware updates. However, updating the smart meter may involve manually replacing each smart meter of the utility system, which is time-consuming By including the MAI in the head end, the software or firmware update may be localized to the head end, and the individual smart meters may not need to be replaced, thereby reducing cost and increasing the efficiency of such upgrades. Updating the head end may be more efficient and economic than updating the smart meters, especially as the complexity of the utility system increases. Further, each head end may service multiple meters, which may further reducing the upgrade effort and cost.

Certain infrastructure, such as an electric smart grid, may include a variety of interconnected systems and components. For example, the smart grid may include power generation systems, power transmission and distribution systems, metering systems, digital communications systems, control systems, and their related components, such as smart meters. Smart meters may incorporate functionalities relating to the consumption of utilities, such as water, electricity, gas, and so forth. However, it may be desirable to simplify the smart meter to provide for a more efficient and scalable utility system. To this end, certain functionality of the smart meter may be relocated to a head end of a utility. The head end generally provides for monitoring and distribution of the utilities, and is located remotely from the end user, the service location, and the smart meters. Thus, the head end may be located within a utility service, a contractor site, or any other location remote from the smart meters.

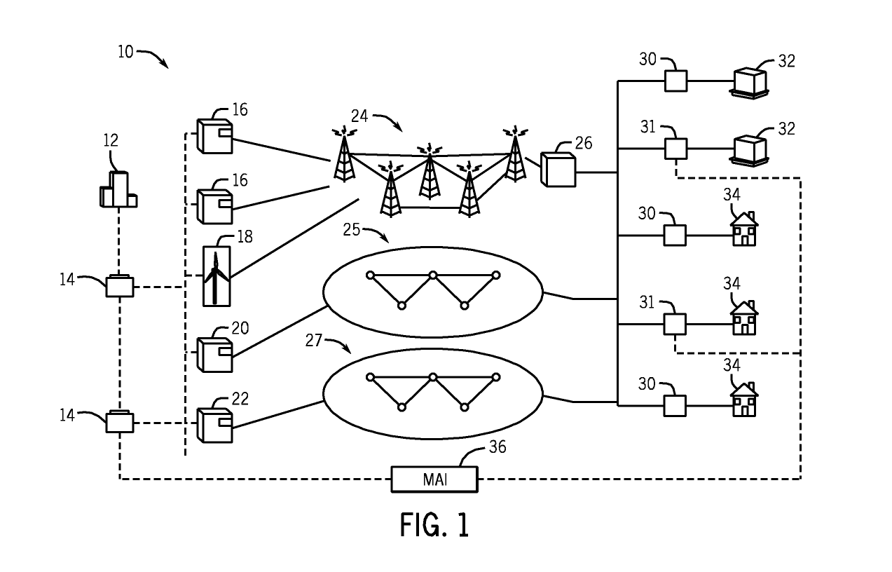

Turning to the figures, FIG. 1 illustrates a utility system 10 that generates, transmits, and distributes a utility (e.g., electricity, water, natural gas, etc.). Accordingly, it should be noted that the systems and methods described herein may apply to a variety of infrastructure, such as power transmission and distribution infrastructure, gas delivery infrastructure, and water delivery infrastructure. As illustrated, the utility system 10 may include one or more utility services 12. The utility service 12 may provide for oversight operations of the utility system 10. For example, one or more utility head ends 14 may monitor and direct utilities produced by one or more utility plants, such as power generation stations 16, alternative power generation stations 18, water processing plants 20, and natural gas processing plants 22.

The power generation stations 16 may include conventional power generation stations, such as power generation stations using gas, coal, biomass, and other carbonaceous products for fuel. The alternative power generation stations 18 may include power generation stations using solar power, wind power, hydroelectric power, geothermal power, and other alternative sources of power (e.g., renewable energy) to produce electricity. The water processing plants 20 may provide potable water, and the natural gas processing plants 22 may provide natural gas. In certain embodiments, the head ends 14, the utility plants 16, 18, 20, 22, or a combination thereof, may reside within the utility service 12.

The power generated by the power generation stations 16, 18 may be transmitted through a power transmission grid 24. Likewise, the water and gas provided by the utility plants 20 and 22 may be delivered through a water distribution grid 25 and a gas distribution grid 27. The distribution grids 24, 25, 27 may cover a broad geographic region or regions, such as one or more municipalities, states, or countries. As depicted, the power transmission grid 24 may include a series of towers to support a series of overhead electrical conductors in a plurality of configurations. For example, extreme high voltage (EHV) conductors may be arranged in a three conductor bundle, having a conductor for each of three phases. In the depicted embodiment, the power transmission grid 24 may be electrically coupled to a power distribution substation 26. The power distribution substation 26 may include transformers to transform the voltage of the incoming power from a transmission voltage (e.g., 765 kV, 500 kV, 345 kV, or 138 kV) to primary (e.g., 13.8 kV or 4160V) and secondary (e.g., 480V, 240V, or 120V) distribution voltages. For example, industrial electric power consumers (e.g., production plants) may utilize a primary distribution voltage of 13.8 kV, while power delivered to commercial and residential consumers may be in the secondary distribution voltage range of 120V to 480V.

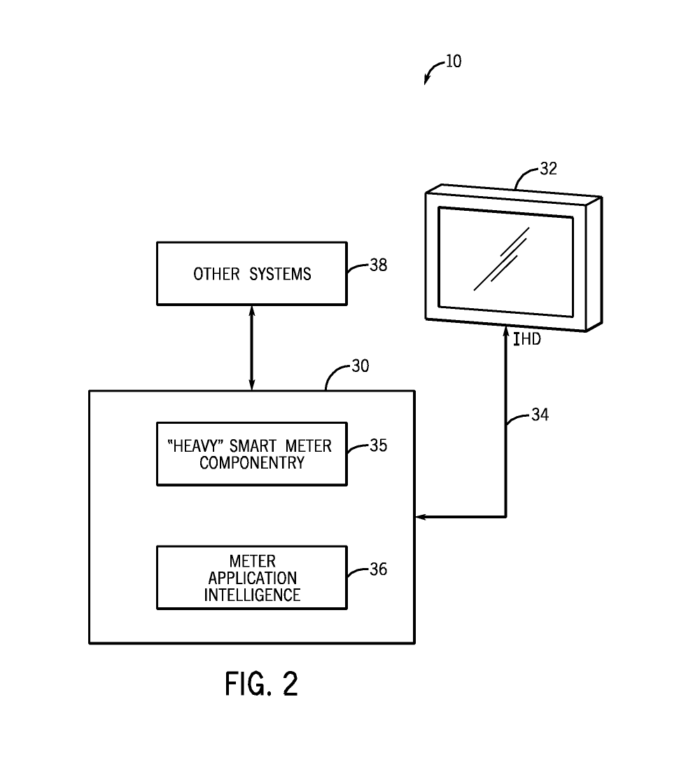

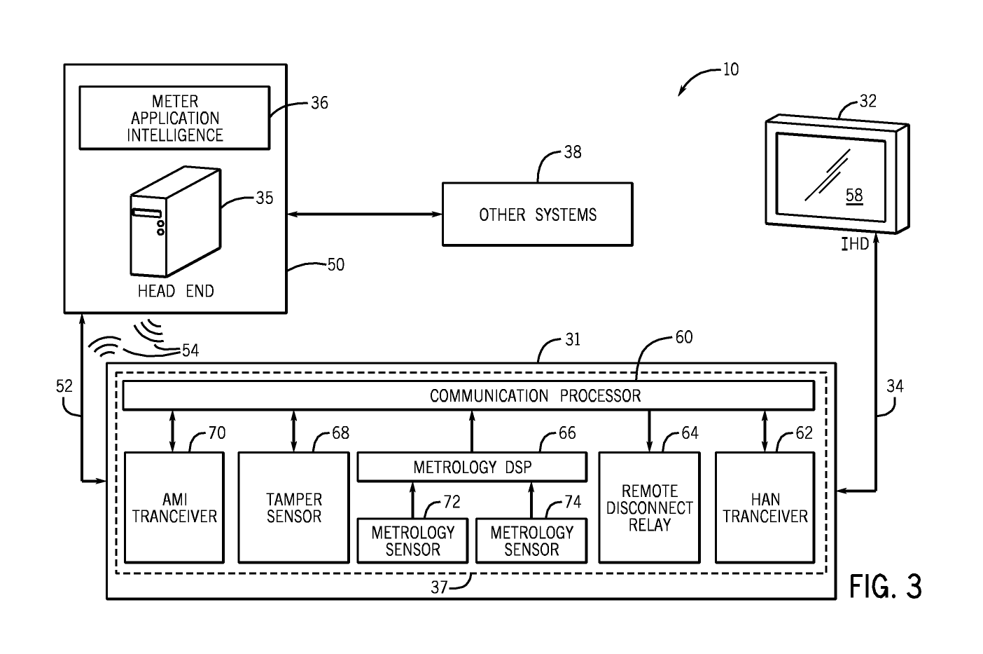

In certain embodiments, the power transmission grid 24 and power distribution substation 26 may communicate data, such as changes in electrical load or demand, to an advanced metering infrastructure (AMI). In addition, the water distribution grid 25 and the gas distribution grid 27 may also communicate data to the AMI, which may include a utility meter (e.g., a heavy meter 30 as described in FIG. 2 or a thin meter 31 as described in FIG. 3). The thin utility meters 31 may enable two-way communication between commercial sites 32, residences 34, and the utility service 12, for example, through the utility head ends 14, thereby providing for a link between consumer behavior and utility consumption (e.g., time, phase angle, temperature, length, speed, volume, corrected volume, volume flux, corrected volume flux, mass, force, energy, pressure, thermal power, active power, apparent power, reactive power, active energy, apparent energy, reactive energy, current, electrical charge, voltage, electric field strength, capacitance, resistance, resistivity, magnetic flux, magnetic flux density, magnetic field strength, inductance, frequency, active energy meter constant or pulse value, reactive energy meter constant or pulse value, apparent energy meter constant or pulse value, volt-squared hour meter constant or pulse value, ampere-squared hour, ampere-squared hour meter constant or pulse value, ampere-squared-hours, mass flux, conductance, temperature, volt-squared hour meter constant or pulse value, ampere-squared hour meter constant or pulse value, volume constant or pulse value, percentage, ampere-hours, energy per volume, calorific value, molar fraction of gas composition, mass density or quantity of material, dynamic viscosity, specific energy, and/or signal strength as they relate to various utility commodity measurements in relation to electricity, gas, water and/or heating water, etc.). Accordingly, the utility meters 30, 31 (e.g., smart meters) may be energy meters, water meters, gas meters, or a combination thereof. For example, the utility meters 30, 31 may track and account for pre-paid electricity, water, and/or gas. Similarly, the utility head end 14 may include a computing server suitable for communicatively connecting to multiple smart meters 30, 31. Likewise, the commercial sites 32 and residences 34 may benefit from lower utility charges by optimizing their utility use, for example, to take advantage of lower rates during low demand hours. Washer/dryers, electric car chargers, and other flexible power consumption appliances may be programmed to operate during low demand hours, resulting in lower utility bills and a more balanced utilization of energy. In certain embodiments, optimizing utility usage to lower utility costs may be included in a meter application intelligence (MAI) 36 of the utility system 10. In certain embodiments, the MAI 36 may be included in the heavy smart meters 30 and/or the utility head end 14. Advantageously, including the MAI 36 in the head end rather than in the smart meters 30, 31 may provide for improved use of computing resources and more efficient updates. Accordingly, the smart meter may be provided as a low cost, low component count smart meter (e.g., “thin” smart meter 31) that leverages the computing power of the utility head end 14, rather than a more expensive and complex heavy smart meter 30 containing the MAI 36. Indeed, the thin smart meter 31 and the utility head end 14 may collaborate to provide for a full array of metering functionality, as explained in more detail herein.

The MAI 36 may also include hardware and/or software instructions to implement various applications to improve the operability or efficiency of the utility system 10. In other words, the MAI 36 may implement any suitable intelligence for providing functionality to the utility system 10 beyond simply measuring raw data (e.g., voltages, currents, etc.) at the smart meter 31. In particular, the functionality of the MAI may include pricing strategies, load profiling, phasor measurements, power network health monitoring, optimization of the power structure (e.g., utilizing capacitor banks), and/or any other suitable applications based on the real-time and/or near real-time data provided by the smart meter 31. For example, the pricing strategies of the MAI 36 may include a time-of-use (TOU) pricing, wherein the cost of electricity is fixed for a specific time period (e.g., 6 months) on a forward basis. The price of electricity may remain unchanged until the specific time period elapses. Additionally or alternatively, the MAI 36 may include critical peak pricing (CPP), wherein time-of-use prices are in effect except for peak days or peak times of day. During these peak demand periods, the prices may increase to reflect the higher cost of generating the electricity. In certain embodiments, the MAI 36 may include real-time pricing (dynamic pricing), wherein the cost of electricity changes relatively frequently (e.g., hourly, semi-hourly, daily) to reflect the true cost of generating the electricity. For certain commercial sites 32 or other large consumers of electricity, the MAI 36 may provide peak load reduction credits when the large consumers of electricity reduce their electrical load demand during peak demand periods. The aforementioned pricing plans are provided by way of example, and are not intended to be limiting. Other pricing strategies may be implemented by the MAI 36, such as cost-plus pricing (i.e. adding a markup to the overall cost of generating electricity), marginal cost pricing (i.e. setting the cost approximately equal to the incremental cost of generating electricity), or other suitable pricing strategies. The utility system 10 may include various components to enable sensing and transmitting data to enable implementations of the aforementioned pricing strategies.

FIG. 2 illustrates an embodiment of the utility system 10 where the MAI 36 is included in the heavy smart meter 30. The utility system 10 includes the heavy utility meter 30, which is communicatively coupled to an in-home display (IHD) 32 via a connection 34 (e.g., wired cable or wireless connection). The in-home display 32 may display metrology data from the utility meter 30 to an end user. The connection 34 may be customer premises equipment (e.g., using a wired or a wireless connection from an internet service provider of the end user), or the connection 34 may be owned by the utility service 12 or a third party.

As shown, the heavy smart meter 30 includes the MAI 36. The heavy utility meter 30 is also communicatively coupled to other systems 38 (e.g., regulatory systems and utility systems). The other systems 38 may verify that the heavy utility meter 30 and the MAI 36 are behaving in a manner consistent with federal, state, and/or municipal regulations, and may provide for other utility-centric services (e.g., costing, heavy smart meter 30 upgrades of hardware and/or software). Also included are “heavy” smart meter components 35, as opposed to “thin” components shown in FIG. 3. The components 35 may include hardware (e.g., electrical and electronic components) and software components useful in providing for the MAI 36. For example, the hardware components 35 may include multi-core processors, redundant processors, random access memory (RAM), read-only memory (ROM), universal serial port (USB) connectors, buffer caches, graphical displays, and so on. The software components 35 may include a high availability operating system, MAI modules (e.g., pricing modules, event logging modules, historical data modules, cost estimation modules, demand load profile modules, utility management modules, and/or the like). As discussed previously, it may be desirable to periodically reconfigure the heavy utility meter 30 to provide for new MAI 36 functionality. Indeed, in some cases, providing the new MAI 36 functionality may include installing a new heavy utility meter 30. Unfortunately, this may result in manual replacement of each individual heavy utility meter 30 of the utility system 10, and may be inefficient, time-consuming, and expensive.

FIG. 3 illustrates a utility system 10 including a head end 14, 50 of the utility service 12 coupled to a “thin” smart meter 31 using components 37 instead of the “heavy” components 35 shown in FIG. 2. Accordingly, the head end 50 includes the MAI 36. The head end 50 may receive and transmit signals to the thin utility meter 31 for data mining and data processing. For example, the head end 50 may receive raw metrology data from the thin utility meter 31. The head end 50 may then process the raw metrology data to implement various pricing strategies, event logging, or other logic to improve the efficiency or operability of the utility system 10. As shown, the head end 50 is communicatively coupled to the thin utility meter 31 via a communications channel 52. The communications channel 52 may be a wired channel (e.g., an Ethernet cable), a wireless channel 54 (e.g., Bluetooth, ZigBee, Wi-Fi, Ethernet or other various IEEE 802 working group standards), a wire-like technology (e.g., RF over wire) or channel (e.g., Power Line Carrier used to send and receive data over an electric power transmission line modulated in RF or electrical signaling), or a non-standard (e.g., proprietary) communication technology, or a combination thereof. In certain embodiments, the head end 50 may function as a virtual meter. In such an implementation, the virtual meter (e.g., the head end 50) may access a database associated with an end-user, rather than communicate with the thin utility meter 31 via the communications channel 52.

The head end 50 is also coupled to other systems 38 (e.g., regulatory systems and utility-related systems), and may also couple the thin smart meter 31 to the other systems 38. As noted previously, the other systems 38 may verify that the behavior of the head end 50 is consistent with government regulations, and may provided for utility-centric services as well as for upgrades to the head end 50. The head end 50 may be coupled to the other systems 38 using, for example, an ANSI C.12.18 (Protocol Specification for ANSI Type 2 Optical Port), ANSI C.12.19 (American National Standard for Utility Industry End Device Data Tables), ANSI C.12.21 (Protocol Specification for Telephone Modem Communication), ANSI C.12.22 (IEEE Draft Standard for Local Area Network/Wide Area Network (LAN/WAN) Node Communication Protocol to complement the Utility Industry End Device Data Table) standard, Meter-Bus (mBus EN 13757-2/3), Wireless mBus (WMBus EN 13757-4), a Device Language Message Specification (DLMS), a Companion Specification for Energy Metering (COSEM), or any other suitable standard or proprietary method for communication, or a combination thereof. For example, some geographic regions may prefer ANSI C.12.18 and ANSI C.12.19, others may prefer DLMS and/or COSEM, and even others may prefer mBus such that the head end 50 may translate between the various communication protocols, as well as provide for a communicative gateway between the other systems 38 and the thin smart meter 31.

As illustrated, the head end 50 includes meter application intelligence (MAI) 36, including associated software and/or hardware components 35. The components 35 may execute software instructions to provide analytics and/or to implement a variety of pricing strategies, such as TOU pricing, CPP, real-time pricing, or a combination thereof For example, the head end 50 may receive a measurement from the thin utility meter 31, receive a timestamp of the measurement, and calculate a cost or pricing information based on the pricing strategy and the measurement. The analytics of the MAI 36 may also include data mining for usage information received from the thin utility meter 31, logging tampering events, controlling the power output to minimize power losses on the transmission grid 24, and provide other functionality.

Advantageously, the MAI 36 and associated components 35 are absent from the thin utility meter 31, thereby simplifying the hardware and software of the thin utility meter 31. As a result of simplifying the thin utility meter 31, updates to the utility system 10 may be performed at the head end 50 without manual replacement of the individual smart meters 30, 31. Updating the head end 50 may be more efficient than updating the heavy smart meters 30, especially as the complexity of the utility system 10 increases. New software-based features may be added to the head end 50 and applied in near real-time to all of the thin smart meters 31 within the utility system 10. Further, including the MAI 36 in the head end 50 may enable additional technologies, such as real-time analytics or higher resolution forecasting, because of the use of additional components (e.g., 3, 4, 5, 6 processors, terabytes of memory, data mining modules, real-time processing modules). Indeed, by using “thin” smart meter computing instead of “heavy” smart meters 30, the utility system 10 may enable improved usage of the smart meter raw data while providing for efficiency updates and lower cost.

The utility system 10 includes the IHD 32, which uses the thin utility meter 31 to communicatively couple to the head end 50. Accordingly, the IHD 32 may receive usage and/or pricing information from the head end 50 and display the information on a display 58. The display 58 may display graphics, buttons, icons, text, windows, and similar features relating to information received from the head end 50. In certain embodiments, the pricing information may be based at least in part on the pricing strategies implemented by the MAI 36 of the head end 50. Because the IHD 32 is configured to display information from the head end 50, the thin utility meter 31 may not include a visual display. The notable exclusion of a display may further simplify the hardware of the thin utility meter 31, which may result in a more flexible and scalable utility system 10.

As shown, the utility meter 31 is communicatively coupled to both the head end 50 and the IHD 32. The “thin” utility meter 31 includes reduced components 37 for sensing metrology data and transmitting the metrology data to the head end 50, when compared to the components 35. As illustrated, the thin smart meter 31 includes a communication processor 60 that is communicatively coupled to a home area network (HAN) transceiver 62, a remote disconnect relay 64, a metrology digital signal processor (DSP) 66, a tamper sensor 68, and an advanced metering infrastructure (AMI) transceiver 70. The communication processor 60 may use various communication methods (e.g., General Packet Radio Service (GPRS), Power Line Carrier (PLC), IEEE 802.XX (Wi-Fi, Ethernet, etc), PRIME, PLC G3, HomePlug, or any other standard or proprietary communication method) to transmit information among these components. Accordingly, the communication processor 60 may execute software instructions to receive and send information among the multiple components of the thin utility meter 31.

For example, in order to enable the display 58 to show pricing and/or usage information from the head end 50, the information may be communicated from the head end 50 to the AMI transceiver 70 and then to the communication processor 60. The communications processor 60 may then route the information to the HAN transceiver 62, which finally sends the information to the IHD 32 to be displayed. In certain embodiments, the communication between the components of the thin utility meter 31 may be performed in real time (e.g., approximately less than 1 millisecond), in near real-time (e.g., approximately between 1 millisecond and 1 second, between 1 second and 5 seconds, between 5 seconds and 10 seconds, between 10 seconds and 1 minute, or a combination thereof) or in delayed time (e.g., once per minute, between one minute and one hour, between one hour and 10 hours, between 10 hours and one a day, between one day and one week, between one week and one month, or a combination thereof). In addition, the communication processor 60 may implement security instructions or routines to provide for secure routing of information among the components of the utility meter 31.

The HAN transceiver 62 (e.g., home communications module) is configured to transmit and receive information from the communication processor 60 and from the IHD 32. For example, the HAN transceiver 62 may receive input from the IHD 32 based on the end-user's utility consumption preferences. Similarly, the AMI transceiver 70 (e.g., head end communications module) is configured to communicate with the head end 50 to transmit measurements detected by the utility meter 31. In certain embodiments, the transceivers 62, 70, may provide for communication using various methods, such as via a wide area network (WAN), a personal area network (PAN), a local area network (LAN), and/or the like.

The utility meter 31 also includes one or more metrology sensors 72, 74. The metrology sensors 72, 74 may detect or read measurements related to a utility. In certain embodiments, the metrology sensors 72, 74 may detect voltages, currents, flow rates, temperatures, pressures, other implementation-specific parameters, or a combination thereof. For example, the metrology sensor 72 may detect a temperature (e.g., using a resistance temperature detector (RTD) thermocouple), and the metrology sensor 74 may detect a current (e.g., using a current transformer (CT) coil, Rogowski coil, and/or electrical shunt). In addition, the metrology sensors 72, 74 may detect measurements continuously (e.g., real-time) or discretely (e.g., near real-time).

The metrology sensors 72, 74 are coupled to the metrology DSP 66. The DSP 66 is configured to receive (e.g., read) the signals from the metrology sensors 72, 74, and to process the signals. In certain embodiments, processing the signals may include calibrating, filtering and/or compressing the signals to derive the measurement based on the signal. For example, the DSP 66 may calculate a difference (e.g., delta) from the previous measurement. In addition, the DSP 66 may filter the signals to remove noise, or the DSP 66 may compress the signals to reduce the amount of information transmitted by the AMI transceiver 70 to the head end 50. In addition, the DSP 66 may also transmit a timestamp indicative of the time the metrology sensors 72, 74 detected the measurement. After the signals from the metrology sensors 72, 74 have been processed, the DSP 66 may transmit the measurements to the communication processor 60. Again, the measurements may include raw metrology data, compressed data, or calculated data (e.g., delta data). The communication process 60 then routes the measurements to the AMI transceiver 70 and ultimately to the head end 50, where the meter application intelligence 36 is implemented. The AMI transceiver 70 may transmit the measurements to the head end 50 in near real-time. Accordingly, the head end 50 may also provide analytics of the measurements and implement MAI 36 in near real-time.

The utility meter 31 includes the tamper sensor 68, which is configured to detect an abnormality with the signal from the metrology sensors 72, 74. The abnormality may be indicative of a tampering (e.g., tamper event) with the metrology sensors 72, 74. For example, removing or disconnecting the metrology sensors 72, 74 may render the thin utility meter 31 dysfunctional. Accordingly, the tamper sensor 68 may alert the head end 50 or the IHD 32 when tampering has been detected, so that the end-user or utility service 12 may take corrective action. In certain embodiments, the tamper sensor 68 may detect a tamper event even without an abnormality within the signal from the metrology sensor 72, 74. For example, the tamper sensor may detect a tamper event when the cover is removed from the utility meter 31, or when there is a change in a magnetic field within the meter 31, even when the utility meter 31 is resistant to the type of tamper and/or is not powered.

The thin utility meter 31 also includes the remote disconnect relay 64. The remote disconnect relay 64 may enable the utility service 12 to selectively enable or disable usage of the utility. For example, if the commercial sites 32 or residences 34 have reached their pre-paid utility limits, if tampering of the thin utility meter 31 has been detected, or for another appropriate reason, the utility service 12 may disable usage of the utility. By further example, enabling or disabling usage of the utility may be based on the pricing strategy of the MAI 36. In another example, a large consumer of electricity may wish to enter a minimum-purchase agreement (i.e., obtain a reduced per-unit cost by agreeing to purchase a minimum amount of units over a time period) with the utility service 12. The remote disconnect relay 64 may enable usage of the utility.

Technical effects of the invention include improving the efficiency and scalability of utility systems by simplifying the hardware of a smart meter and thus providing a “thin” smart meter. In particular, meter application intelligence (MAI) hardware and software can be removed from the meter and relocated to a head end of a utility service. By including the MAI in the head end, the software or firmware updates may be localized to the head end, thereby increasing the efficiency such upgrades. For example, new software-based features may be added to the head end and applied in real-time to all of the smart meters within the utility system. Accordingly, the path for feature amendments to the utility system 10 may be easier, and may be provided for without affecting the smart meters of the end-users.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a utility head end comprising a meter application intelligence (MAI);
a utility meter configured to communicatively couple to the utility head end, the utility meter comprising:
a metrology sensor configured to read a measurement related to a utility; and
a head end communications module configured to communicate with the utility head end to transmit the measurement for use by the MAI.

2. The system of claim 1, wherein the head end communications module is configured to transmit the measurement in approximately near-real time, and wherein approximately near real-time comprises approximately between 1 millisecond and 1 minute.

3. The system of claim 1, wherein the MAI is configured to implement an event logging module, a utility management module, one or more pricing strategies, phasor measurements, power network health monitoring, or optimization of power structure, or a combination thereof, wherein the one or more pricing strategies comprises at least one of a time-of-use (TOU) pricing, Load Profile (LP), a critical peak pricing (CPP), or a real-time pricing.

4. The system of claim 1, wherein the utility meter comprises:
a tamper sensor configured to detect an abnormality with the utility meter as an indication of a tamper event associated with the utility meter;
a digital signal processor configured to receive the measurement from the metrology sensor and to calibrate, filter, and/or compress the measurement;
a remote disconnect relay configured to enable or disable usage of the utility;
a communication processor communicatively coupled to, and configured to receive and send information among, the head end communications module, the tamper sensor, the metrology sensor, the digital signal processor, and the remote disconnect relay; and
a user end communications module configured to receive input from a user and to communicate the input to the communication processor.

5. The system of claim 4, wherein the metrology sensor is configured to detect at least one of a voltage, a current, a flow rate, a temperature, a pressure, or any combination thereof, related to the utility.

6. The system of claim 1, wherein the utility meter comprises an energy meter, a gas meter, a water meter, or a combination thereof, and wherein the utility meter does not include a visual display.

7. The system of claim 1, comprising an in-home display (IHD), wherein the IHD is configured to use the utility meter to communicatively couple to the utility head end.

8. The system of claim 7, wherein the IHD is configured to receive usage or pricing information from the utility head end, and the pricing information is based at least in part on a pricing strategy.

9. The system of claim 1, wherein the MAI is configured to provide near real-time analytics based on the measurement.

10. The system of claim 1, wherein the utility head end is communicatively coupled to a regulatory system by using a C12.X protocol, a Device Language Message Specification (DLMS), a Companion Specification for Energy Metering (COSEM), a Meter-Bus (mBus EN 13757-2/3), Wireless mBus (WMBus EN 13757-4), or any combination thereof.

11. The system of claim 1, comprising a communications channel configured to communicatively couple the utility head end to the utility meter, wherein the communications channel comprises a wired channel, a wireless channel, a wire-like technology, or a combination thereof

12. A system comprising:
a utility head end configured to communicate with a utility meter, the utility head end comprising:
a non-transitory machine-readable medium comprising code configured to:
receive a measurement from the utility meter;
receive a timestamp of the measurement; and
calculate pricing information based on the measurement, the timestamp, and a pricing strategy, by using a meter application intelligence (MAI).

13. The system of claim 12, wherein the pricing strategy comprises a time-of-use (TOU) pricing, load profiling (LP), a critical peak pricing (CPP), a real-time pricing, or a combination thereof, and the MAI is configured to implement an event logging module, a utility management module, a cost estimation module, phaser measurements, power network health monitoring, or optimization of power structure, or a combination thereof

14. The system of claim 12, wherein the measurement comprises raw data, compressed data, or calculated data.

15. The system of claim 14, comprising the utility meter having a non-transitory machine-readable medium comprising code configured to:
detect an abnormality with the utility meter as an indication of a tamper event associated with the utility meter;
implement at least one of an event logging module, a utility management module, a cost estimation module, or a combination thereof, based on the tamper event.

16. The system of claim 12, wherein the utility meter comprises:
a metrology sensor configured to read the measurement related to a utility;
a tamper sensor configured to detect an abnormality with the utility meter as an indication of a tamper event associated with the utility meter;
a remote disconnect relay configured to enable or disable usage of the utility based on the tamper event;
a digital signal processor configured to receive the measurement from the metrology sensor and to calibrate, filter, and/or compress the measurement;
a head end communications module configured to receive the measurement from the digital signal processor and to communicate with the utility head end to transmit the measurement to the utility head end in approximately near real-time;
a communication processor communicatively coupled to, and configured to receive and send information among, the head end communications module, the tamper sensor, the metrology sensor, the digital signal processor, and the remote disconnect relay; and
a user end communications module configured to receive input from a user and to communicate the input to the communication processor.

17. A method comprising:
receiving a signal related to a measurement of a utility;
deriving a timestamp of the signal;
calculating pricing information based on the measurement, the timestamp, and a pricing strategy of a meter application intelligence (MAI) remote from a utility meter; and
transmitting the pricing information to at least one of a regulatory system or the utility meter.

18. The method of claim 17, wherein transmitting the cost uses a wired channel, a wireless channel, a wire-like channel, or a combination thereof

19. The method of claim 17, comprising enabling or disabling the utility based on the pricing strategy.

20. The method of claim 19, wherein the pricing strategy comprises a time-of-use (TOU) pricing, a critical peak pricing (CPP), a real-time pricing, or a combination thereof.
